(19) United States
(12) Patent Application Publication
(10) Pub. No.: US 2008/0059619 A1
(43) Pub. Date: Mar. 6, 2008

(54) Configuring a Perimeter Network

(75) Inventors: Dean Merritt Wierman, Bellevue, WA (US); Sarabjit Singh Seera, Redmond, WA (US); Dmitry V. Zhiyanov, Bothell, WA (US); Patrick F. Hogan, Seattle, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/469,057

(22) Filed: Aug. 31, 2006

(51) Int. Cl. G06F 17/30; G06F 15/173; G06F 15/16

(52) U.S. Cl. 709/223; 707/10; 709/203

(57) ABSTRACT

Given a three legged network setup, the method will automatically check necessary settings to ensure that a business application can be set up to be available over the Internet.

### BACKGROUND

Correctly and securely setting up and configuring an Internet-facing perimeter network for a business application is a complex task with many opportunities for errors which either render a software application inoperable or result in unintended security vulnerabilities as people skilled at setting up a business application often are not skilled at setting up Internet facing networks. One response has been for business application vendors define Internet-facing topologies for each of their applications. These topologies are designed to make each specific application easy to use but often results in differing topology requirements between applications. As a result, customers face higher costs as numerous topologies make setting up the numerous Internet facing topologies even more complicated.

### SUMMARY

Setting up an Internet facing perimeter network for a business application without being a security risk is made easier by defining a three legged network setup and implementing a method to automatically check on relevant settings to ensure that an application can be set up to be available over the Internet. To set up such a network, data may be collected on whether a security server application is present and whether it is a proper version. In addition, the proper number of network cards may be determined and if the network cards are active. Further, a security server application may be configured by collecting relevant IP addresses and the application may be made available using the collected data.

### DRAWINGS

FIG. 1 is a block diagram of a computing system that may operate in accordance with the claims;

FIG. 2 is an illustration of a sample hardware setup to operate a method of setting up an Internet facing business application;

FIG. 3 is an illustration of a method of setting up an Internet facing business application; and

FIG. 4 is an illustration of a method of setting up an application to be available over the Internet.

### DESCRIPTION

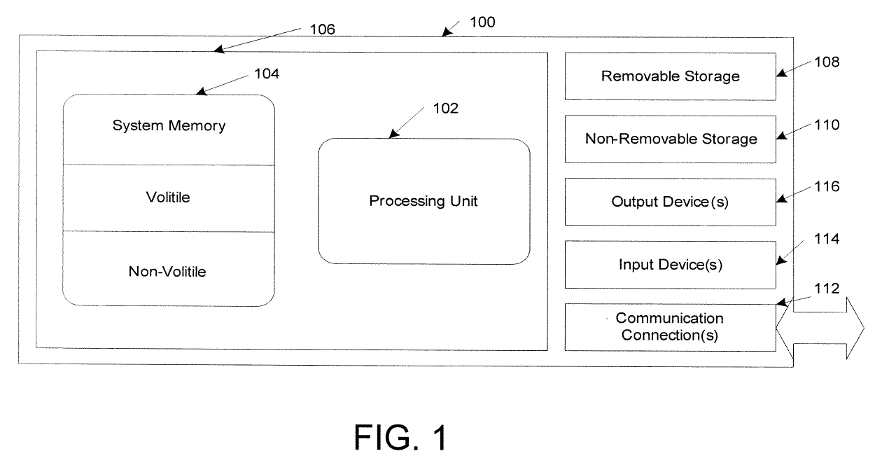

FIG. 1 illustrates an example of a suitable computing system environment 100 on which a system for the claimed method and apparatus may be implemented. The computing system environment 100 is only one example of a suitable computing environment and is not intended to suggest any limitation as to the scope of use or functionality of the method of apparatus of the claims. Neither should the computing environment 100 be interpreted as having any dependency or requirement relating to any one or combination of components illustrated in the exemplary operating environment 100.

The claimed method and apparatus are operational with numerous other general purpose or special purpose computing system environments or configurations. Examples of well known computing systems, environments, and/or configurations that may be suitable for use with the methods or apparatus of the claims include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The steps of the claimed method and apparatus may be described in the general context of computer-executable instructions, such as program modules, being executed by a computer. Generally, program modules include routines, programs, objects, components, data structures, etc. that perform particular tasks or implement particular abstract data types. The methods and apparatus may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the steps of the claimed method and apparatus includes a general purpose computing device in the form of a computer 1 10. With reference to FIG. 1, an exemplary system for implementing the invention includes a computing device, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106. Additionally, device 100 may also have additional features/functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

Device 100 may also contain communications connection(s) 112 that allow the device to communicate with other devices. Communications connection(s) 112 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Device 100 may also have input device(s) 114 such as keyboard, mouse, pen, voice input device, touch input device, etc. Output device(s) 116 such as a display, speakers, printer, etc. may also be included. All these devices are well know in the art and need not be discussed at length here.

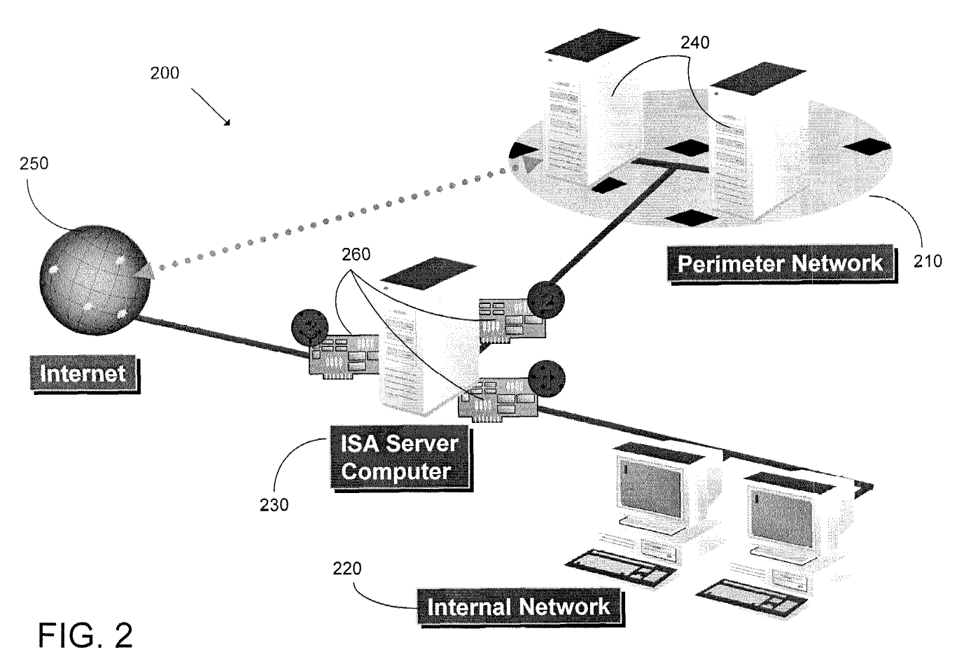

FIG. 2 is an illustration of a three legged network 200 for which a method of configuring an Internet facing business application using a perimeter network 210 may be used. The three legged network 200 may have a network region separate from a private internal network 220 but with restricted external access. The three legged network 200 may give un-trusted users access to required data while minimizing risk to the internal network 220. The three legged network 200 may have a security server 230 that has firewall or security functionality such as an Internet Security and Acceleration (“ISA”) server that sifts and routes traffic to and from the internal network 220 (or intranet), to and from the perimeter network 210 (which may have one or more Internet servers 240 such as Internet information servers “IIS”) and to and from the Internet 250. An IIS server may be one or more Internet servers 240 (including a Web or Hypertext Transfer Protocol server and a File Transfer Protocol server) with additional capabilities for Microsoft's Windows NT® and Windows 2000 Server® operating systems. Other Internet servers 240 may use software with similar functionality such as software from Apache, Sun Microsystems, O'Reilly, and others. The Internet 250, the perimeter network 210 and perimeter network 210 may communicate with the security server 230 using a network interface card 260 or the like.

The ISA server may be a server 230 computer with appropriate software that may enable a multi-networking model that allows network managers to control traffic between internal and external networks, and within an organization by means of firewall policy rules. A network manager may define network objects in an ISA server management module, for example, and configure relationships to specify whether traffic should be routed between them, or have network address translation (NAT) applied. The network objects that the network manager defines may be used as source and destination elements in access rules configured to specify what traffic is allowed or denied between networks. The general process of configuring the ISA server may be summarized as follows:

Create network objects, or modify ISA server predefined network objects. Network objects may allow a network manager to define included networks (a range of Internet Protocol (IP) addresses), network sets (set of networks), computers, computer sets, address ranges (set of contiguous IP addresses), subnets, Uniform Resource Locator (URL) sets, and domain name sets.

Create network rules to configure how traffic is passed between networks in an organization. The ISA server may check network rules to determine whether source and destination networks are allowed to connect, and if so, whether traffic requests should be routed or have NAT applied.

Create firewall policy rules to expose traffic between networks to stateful filtering and application layer traffic inspection. Traffic may be allowed or denied based on the parameters in the network rules.

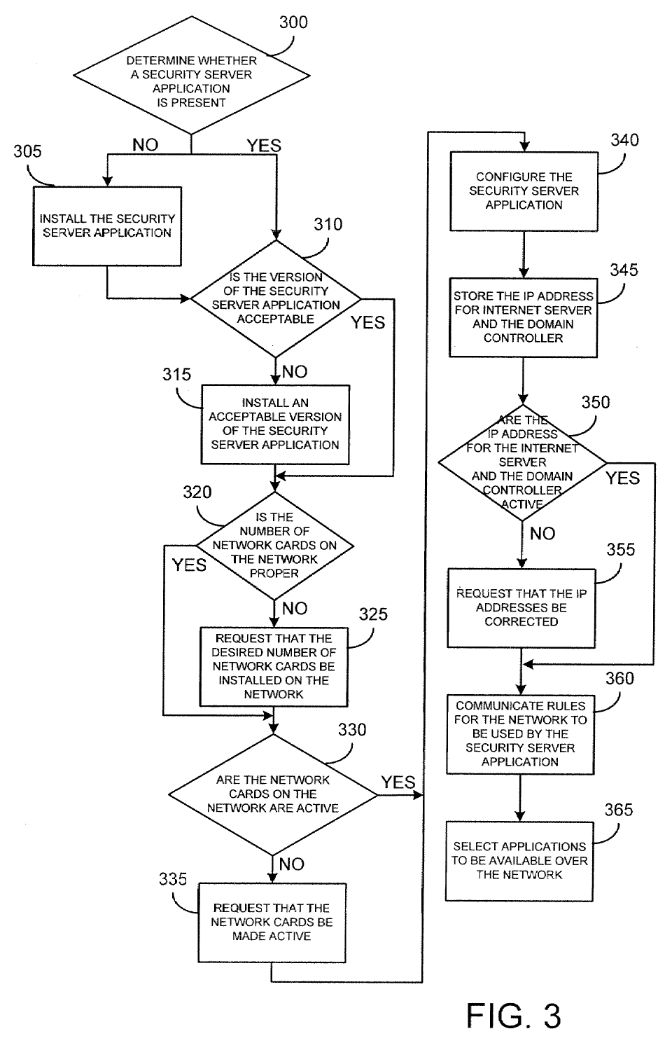

Any of the computers in FIG. 2 may be like the computer 110 described in FIG. 1 configured with appropriate software. The internal network 220 may contain applications such as business applications like a database application or a customer relationship management (“CRM”) system that an external user may desire to access remotely such as through the Internet 250. In the past, it has been difficult for non-technical users to set up an Internet 250 facing network and the method described in FIG. 3 may make such a process easier.

FIG. 3 illustrates a method of setting up a three legged network 200 for an Internet enabled business application. At block 300, the method may determine whether the security server application 230, such as the ISA server application, is present.

At block 305, if the security 230 application is not present, the method may install the security server 230 application, such as the ISA server application. Without a proper security server, the three legged network 200 may be vulnerable to unwanted attacks. In another embodiment, the method may store data about the progress of the method, request that the security server 230 application be installed and stop the method until the security server 230 application is installed. The stored data may be stored in a log file, for example, and the data may be used for support functions. For example, the log file may be sent to a software support specialist and the software support specialist may be able to understand the blocks completed by the user and any blocks that may have failed. In yet another embodiment, the stored data may be used to replicate the steps taken by a user for a software support specialist such that the software support specialist can see virtually the same steps taken by a user and a resulting problem. As such, the software support specialist can better diagnose the problems, propose better solutions and test proposed solutions. In addition, the log file may be viewed at virtual any block of the method.

At block 310, the method may determine a version of the security server 230 application. At block 315, if the version of the security server 230 application is not satisfactory, an acceptable version of the security server 230 application may be installed. Security servers 230 have been around for some time and some security server 230 applications may be too far out of date to be used by the method.

At block 320, the method may determine the number of network cards 260 on the computer that is hosting the security server 230 application. At block 325, if the number of network cards 260 on the three legged network 200 is not a desired number, the method may request that the desired number of network cards 260 be installed on the three legged network 200. In an alternate embodiment, the method may store data related to the progress of the method, request that the desired number of network cards 260 be installed on the three legged network 200 and the method may stop until the proper number of network cards 260 are installed. In one embodiment the proper number of network cards 260 is three such as in FIG. 2 where each of the internal network 220, the perimeter network 210 and Internet 250 have individual network cards 260 in the security server 230 computer. The network cards 260 should not have matching MAC addresses else confusion and collisions may result.

At block 330, it may be determined whether the network cards 260 on the three legged network 200 are active. If the network cards 260 are not active, at block 335, the method may request that the network cards 260 be made active. If the network cards 260 are not active, proper communication within the three legged network 200 may not occur. In an another embodiment, the method may store data related to the progress of the method, request that the network cards 260 be made active on the three legged network 200 and the method may stop until the network cards 260 are made active.

At block 340, the method may configure the security server 230 application by collecting an internet protocol (IP) address of the Internet server 240 in the perimeter network 210 and an IP address of a domain controller on the internal network 220. At block 345, the method may store the IP addresses for the Internet 240 server and the domain controller.

At block 350, the method may validate the IP addresses for the Internet server 240 and the domain controller from block 340. If the IP addresses for the Internet server 240 and domain controller cannot be validated, at block 355 the method may request that the IP addresses for the Internet server 240 and domain controller be corrected. Without proper IP addresses or valid IP addresses, communication in the three legged network 200 may not occur as desired.

At block 360, the method may communicate rules for the network to be used by the security server 230. The security server 230 rules may determine what network resources client machines are permitted to access. The rules may be used to control incoming traffic from the Internet 250 to the internal network 220, and outgoing traffic from the internal network 220 to the Internet 250. There may be several types of rules supported by the security server 230. These rules may include access policy, bandwidth, protocol, routing and chaining, scheduling, server publishing, site and contents, and Web publishing rules. A sample rule may be a requirement that access over the Internet 250 uses 128 bit encryption, and that the Internet 250 connection be SSL enabled.

At block 360, the method may select applications to be available over the three legged network 200. The application may be a business application, such as a CRM application, for example.

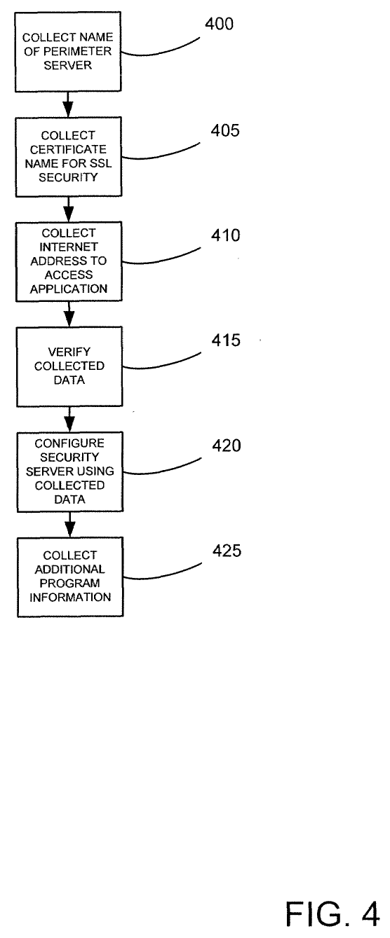

FIG. 4 may be an illustration of a display that may be used to gather information for the business application that is to be made available from block 360, such as Microsoft CRM®. At block 400, the name of the perimeter server 210 may be entered. The name may be selected using a drop down box or inputted manually. In an alternative embodiment, the server that assists the business application may be inputted. For example, Microsoft SQL® may be used to assist Microsoft CRM. Another input block may be for the helper application reporting server, such as the Microsoft SQL reporting server.

At block 405, the certificate name for SSL security may be inputted. The name may be selected from a drop down list or inputted manually. At block 410, an Internet address that is to be used to access the business application may be inputted. At block 415, the method may verify the inputted values from blocks 400 through 410. As the verification proceeds, visual indications may be displayed to the user that the inputted values have been verified. If the values are not verified, the specific values that were not verified are highlighted to be corrected. If problems persist, the user may ask for help. All the inputted data from blocks 400 through 415 may be stored in a log file.

At block 420, the security server 230, such as a Microsoft ISA server, may be configured using the data from blocks 400-415. In addition, actual connectivity may be checked and status may be displayed. At block 425, data from additional business programs that are to be available over the Internet may be collected and verified.

At multiple points in the method, data may be stored regarding the progress of the method. The data may be stored in a file such as a log file that can be used by support to analyze the steps taken and the results. The data may be fed into a system that creates the displays that the user viewed, fills in the data the user entered and displays the resulting displays. In this way, support personnel may be better able to track problems. Further, software designers may be able to view how users navigate through the software and determine if the flow is as desired or could be improved.

As a result of the method, the process of setting up a business application to be available over the Internet using a three legged network is greatly simplified. The steps to configure the network have been automated into a series of easy to follow displays. If there is a problem at any step of the method, the method may stop at that point and inform the user that there is a problem. In this way, users will know of problems virtually immediately. The method will log the steps as performed and if problems occur, the method may be used to view the progress of the method up to the point problems occurred.

Although the forgoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

1. A method of setting up a network for an Internet enabled application comprising:
determining whether a security server application is present;
if the security server application is not present, installing the security server application;
determining a version of the security server application;
if the version of the security server application is not satisfactory, installing an acceptable version of the security server application;
determining a number of network cards on the network;
if the number of network cards on the network is not a desired number, requesting that the desired number of network cards be installed on the network;
determining if the network cards on the network are active;
if the network cards are not active, requesting that the network cards be made active;
configuring the security server application by collecting internet protocol (IP) addresses of an Internet server and of a domain controller on the network;
storing the IP address for the Internet server and the domain controller;
validating the IP address for the Internet server and the domain controller;
if the IP addresses cannot be validated, requesting that the IP addresses be corrected;
communicating rules for the network to be used by the security server; and
selecting applications to be available over the network.

2. The method of claim 1, wherein the network is a three legged network and wherein the desired number of network interface cards is three.

3. The method of claim 1, wherein the application is a business application.

4. The method of claim 1, wherein if the security server application is not present:
requesting that the security server application be installed; and
causing the method to wait for the security server application to be installed

5. The method of claim 1, wherein if the version of the security server application is not the proper version:
requesting that the proper version of the security server application be installed; and
stopping the method until the proper version of the security server application is installed.

6. The method of claim 1, further comprising if the number of network cards on the network is not a desired number:
requesting that the desired number of network cards be installed on the network; and
stopping the method.

7. The method of claim 1, further comprising if the network cards on the network are not active:
requesting that the network cards be made active; and
stopping the method.

8. The method of claim 1, wherein if the IP addresses cannot be validated:
offering suggestions on how to validate the IP addresses; and
allowing corrections to validate the IP addresses and if the IP addresses cannot be validated, stopping the method

9. The method of claim 1, further comprising creating a file that contains the steps of the method taken and the results of the steps such that the file can be sent to another device and the file enables the other device to view the steps of the method taken and the results of the steps.

10. The method of claim 1, wherein the rules comprise a requirement that access Internet access uses 128 bit encryption, and that a secured socket layer is used to connect to the Internet.

11. A computer system comprising a processor for executing computer executable code, a memory for storing data and computer executable code and an input/output circuit comprising computer executable instructions for setting up a network for an Internet enabled application comprising:
determining whether a security server application is present;
if the security server application is not present:
requesting that the security server application be installed; and
stopping until the security server application is installed;
determining a version of the security server application;
if the version of the security server application is not satisfactory:
requesting that the proper version of the security server application be installed; and
stopping until the proper version of the security server application is installed;
determining a number of network cards on the network;
if the number of network cards on the network is not a desired number:
requesting that the desired number of network cards be installed on the network; and
stopping until the desired number of network cards is installed;
determining if the network cards on the network are active;
if the network cards are not active, requesting that the network cards be made active;
configuring the security server application by collecting internet protocol (IP) addresses of an Internet server and of a domain controller on the network;
storing the IP addresses for the Internet server and the domain controller;
validating the IP addresses for the Internet server and the domain controller;
if the IP addressees cannot be validated, requesting that the IP addresses be corrected:
storing data related to the progress of the method;
offering suggestions on how to validate the IP addresses; and
allowing corrections to validate the IP addresses and if the IP addresses cannot be validated, stopping the method; and
selecting applications to be available over the network.

12. The computer system of claim 11, wherein the network comprises a three legged network and wherein the desired number of network interface cards is three.

13. The computer system of claim 11, wherein the application is a business application.

14. The computer system of claim 11, further comprising creating a file that contains the computer executable instructions that were executed and the results of the computer executable instructions such that the file can be sent to another device and the file enables the other device to view the computer executable instructions taken and the results of the computer executable instructions.

15. The computer system of claim 11, wherein rule comprise a requirement that access over the internet uses 128 bit encryption, and that a secured socket layer be used to connect to the Internet.

16. A computer readable medium for storing computer executable code wherein the computer executable code comprises instructions for a method of setting up a network for an Internet enabled application comprising:
determining whether an internet security and acceleration (ISA) server application is present;
if an ISA server application is not present:
storing data related to the progress of the method;
requesting that ISA be installed; and
stopping the method until ISA is installed;
determining a version of the ISA server application;
if the version of the ISA server application is not satisfactory
storing data related to the progress of the method;
requesting that the proper version of the ISA be installed; and
stopping the method until the proper version of the ISA is installed;
determining if there are three network cards on the network;
if the number of network cards on the network is not three:
storing data related to the progress of the method;
requesting that three network cards be installed on the network; and
stopping the method.
determining if the network cards on the network are active;
if the network cards are not active, requesting that the network cards be made active;
configuring the ISA server application by collecting internet protocol (IP) addresses of an internet information services (IIS) server and of a domain controller on the network;
storing the IP address for the IIS server and the domain controller;
validating the IP address for the IIS server and the domain controller;
if the IP addresses cannot be validated, requesting that the P addresses be corrected:
storing data related to the progress of the method;
offering suggestions on how to validate the IP addresses; and
allowing corrections to validate the IP addresses and if the IP addresses cannot be validated, stopping the method; and
selecting applications to be available over the network.

17. The computer readable medium of claim 16, further comprising computer executable code for creating a file that contains the steps of the method taken and the results of the steps such that the file can be sent to another device and the file enables the other device to view the steps of the method taken and the results of the steps.

18. The computer readable medium of claim 16, wherein the rules comprise a requirement that access over the Internet uses 128 bit encryption, and that the Internet connection be SSL enabled.
